(19) United States
(12) Patent Application Publication
(10) Pub. No.: US 2007/0213108 A1
(43) Pub. Date: Sep. 13, 2007

(54) RECOGNIZABLE MODEL

(75) Inventor: Feng-Ting Hsu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: JENSIN INTL TECHNOLOGY CORP., Taipei County (TW)

(21) Appl. No.: 11/682,882

(22) Filed: Mar. 7, 2007

(30) Foreign Application Priority Data
Mar. 7, 2006 (TW) 95107549

(51) Int. Cl. A63F 13/00; A63F 9/24

(52) U.S. Cl. 463/1; 463/8

(57) ABSTRACT

A recognizable model for an online game having multiple character roles, pets, stage artifacts, pieces or equipment is provided. The recognizable model includes a body and an identifiable chip disposed inside the body. The identifiable chip has a specific serial number that corresponds to one of the character roles, pets, stage artifacts, pieces or equipment of the online game.

### CROSS-REFERENCE TO RELATED APPLICATION

This application claims the priority benefit of Taiwan application serial no. 95107549, filed on Mar. 7, 2006. All disclosure of the Taiwan application is incorporated herein by reference.

### BACKGROUND OF THE INVENTION

1. Field of the Invention

The present invention relates to a model, and more particularly to a recognizable model with a specific serial number.

2. Description of Related Art

With the popularization of computer and the rapid progress in network communication, computer games has evolved from the former single machine version into a mode of operation that permits a number of people in different locations to battle with one another online simultaneously.

For example, popular computer network game providers allow a number of people to go on line and play games together through a server. The game companies provide the story lines of these online games and the game players are free to choose the particular character roles they want to play or create their own character role. Then, by battling monsters in the game, completing a specified mission according to the directions, or trading with other game players or shopping around, precious items including other character roles, pets, stage artifacts or equipment are obtained. These precious items are able to enhance the attack or defense capability of the character roles in the game. To obtain pieces or precious items from the game, the players need to spend considerable time and effort battling with the monster or accomplishing the mission.

However, most of the games are designed in such a way that pieces or other precious items will drop from the body of the monster in the vicinity of the role player when the monster is hit. Therefore, in the process of attacking the monster, other online game players may easily steal these dropped-out pieces or precious items without attacking the monster themselves leading to question about the fairness of the game.

Moreover, when the player wishes to retrieve the stolen pieces or precious items through the game company, there is no proof that the pieces or the precious items are stolen. Therefore, the game company cannot return these pieces or precious items to the original owner. Hence, these pieces or precious items are forever lost to the player.

### SUMMARY OF THE INVENTION

Accordingly, at least one objective of the present invention is to provide a recognizable model for resolving the problem of having pieces and precious items stolen from a player in an online game.

To achieve these and other advantages and in accordance with the purpose of the invention, as embodied and broadly described herein, the invention provides a recognizable model. The recognizable model is designed according to an online game having multiple character roles, pets, stage artifacts, pieces or equipment. The recognizable model includes a body and an identifiable chip disposed inside the body. The identifiable chip has a specific serial number that corresponds to one of the character roles, pets, stage artifacts, pieces or equipment of the online game.

In one embodiment of the present invention, the foregoing specific serial number is built inside the identifiable chip.

In one embodiment of the present invention, the foregoing specific serial number is input into the identifiable chip through an input interface.

In one embodiment of the present invention, the foregoing identifiable chip includes a radio frequency identification (RFID) chip, a Bluetooth chip or a wireless network chip.

In one embodiment of the present invention, the aforementioned body is fabricated into a form resembling the character roles, pets, stage artifacts, pieces or equipment in the online game.

The recognizable model in the present invention is a real world replica of the objects in the virtual world. Because the precious items of the players such as the character roles, pets, stage artifacts, pieces or equipment in the online game and the recognizable model have the same specific serial number, the player can use the recognizable model with the specific serial number as a proof for asking the game company to return any stolen items if precious items have been stolen in the game. In other words, the present invention is able to avoid the problem of having precious items stolen from an online game player.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a recognizable model according to the present invention.

FIG. 2 is a perspective view of a recognizable model and a top view of an input interface according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

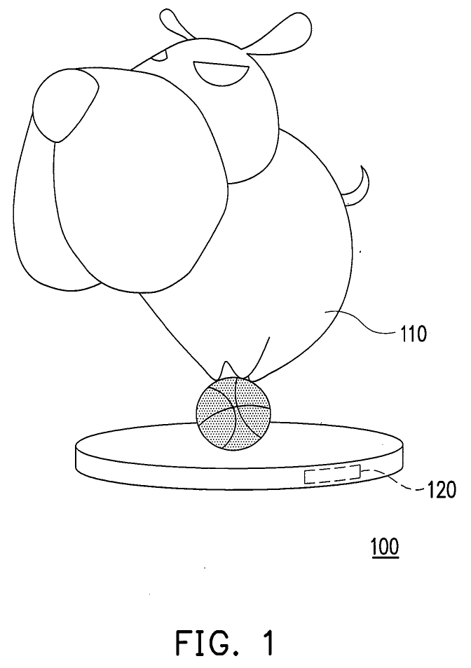

FIG. 1 is a perspective view of a recognizable model according to the present invention. As shown in FIG. 1, the recognizable model 100 in the present invention is designed according to the precious items such as character roles, pets, stage artifacts, pieces or equipment of different online games. Therefore, the recognizable model 100 in the present invention is not limited to the form shown in FIG. 1. In other words, the shape of the recognizable model 100 may vary according to the type of online game and the particular character roles, pets, stage artifacts, pieces or equipment of the online game.

The recognizable model 100 in the present invention includes a body 110 and an identifiable chip 120. The body 110 is fabricated into a shape that corresponds to the character roles, pets, stage artifacts, pieces or equipment of an online game. The identifiable chip 120 is disposed inside the body 110, but is not necessarily limited as such. In other words, the identifiable chip 120 may be disposed on a surface of the body 110. The identifiable chip 120 has a specific serial number. This specific serial number corresponds to the serial number of precious items such as character roles, pets, stage artifacts, pieces or equipment of the online game. In the present embodiment, the identifiable chip 120 can be a radio frequency chip, a Bluetooth chip or a wireless network chip.

The specific serial number in the identifiable chip 120 is provided through the network company. Furthermore, the specific serial number is, for example, letters, numbers or a combination of letters and numbers. More specifically, a player who purchases the installation pack of an online game or a time card also receives a recognizable model as a free gift accompanying the installation pack or the time card. The identifiable chip 120 inside the recognizable model 100 has a built-in specific serial number that corresponds to the serial number of precious items such as the character roles, pets, stage artifacts, pieces or equipment of the online game. After the player has registered with the game company using the registered serial number on the installation pack or time card and the game company has verified the registration, the role played by the player is eligible for collecting precious items in the game. In real life, the player obtains a recognizable model 100 that corresponds to the characters in the game. In this way, the player not only collects precious items in the virtual game world, but also obtains a model, a solid collectible item in the real world, that resembles the precious items in the game.

In addition, when the character role in the game attacks or set up defense, although the precious items or pieces belonging to the role player may still drop off around the role player, the role player does not have to worry about stolen items not being returned. More specifically, the player is in possession of a specific serial number that is identical for both the recognizable model 100 and the precious items in the game. Therefore, if precious items are stolen, the role players may use the recognizable model 100 as a proof that the items belong to them and ask the game company to return them those items.

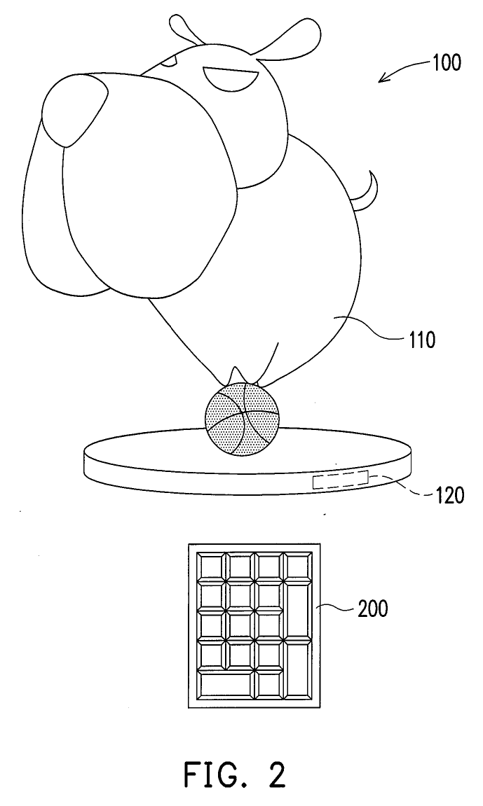

FIG. 2 is a perspective view of a recognizable model and a top view of an input interface according to the present invention. As shown in FIG. 2, a player may enter a specific serial number into the identifiable chip 120 of the recognizable model 100 through an input interface 200. For example, the identifiable chip 120 inside the recognizable model 100 owned by a player may not have a specific serial number. After the player has performed some maneuvers and obtained a few precious items, the player is given the specific serial number of these precious items. Because each precious item has a corresponding specific serial number, the player may input the specific serial number of these precious items into the identifiable chip 120 through the input interface 200. In one embodiment, the input interface 200 is a keyboard, which inputs the specific serial number into the identifiable chip 120, for example, through a wireless connection. Therefore, the recognizable model 100 in the present invention also provides the convenience of allowing the player to input the specific serial numbers themselves.

In summary, the recognizable model in the present invention has a specific serial number that corresponds to the precious items in the game. Therefore, the recognizable model is an actualization of the precious items in the virtual world. When the precious items in the online game are stolen from a player, the player can use the recognizable model, which has the same specific serial number as the precious items, as a proof and ask the game company to return those stolen items. Furthermore, the recognizable model also provide the players with the convenience of inputting the specific serial numbers of precious items themselves after obtaining the items through the game. In addition, the recognizable model in the present invention is shaped into a form looking like the character roles, pets, stage artifacts, pieces or equipment of different online games. Therefore, the recognizable model can be a meaningful and valuable item for collectors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A recognizable model suitable for an online game, wherein the online game has multiple character roles, pets, stage artifacts, pieces and equipment, comprising:
a body; and
an identifiable chip disposed inside the body, wherein the identifiable chip has a specific serial number that corresponds to one of the character roles, pets, stage artifacts, pieces or equipment of the online game.

2. The recognizable model of claim 1, wherein the specific serial number is built inside the identifiable chip.

3. The recognizable model of claim 1, wherein the specific serial number is input into the identifiable chip through an input interface.

4. The recognizable model of claim 1, wherein the identifiable chip includes a radio frequency identification chip, a Bluetooth chip or a wireless network chip.

5. The recognizable model of claim 1, wherein the body is fabricated into a form resembling the character roles, pets, stage artifacts, pieces or equipment of the online game.
